(19) United States
(12) Patent Application Publication
(10) Pub. No.: US 2018/0313787 A1
(43) Pub. Date: Nov. 1, 2018

(54) Isolation of Circulating Tumor Cells Using Electric Fields

(71) Applicant: BioForce Medical, Inc., Mesa, AZ (US)

(72) Inventors: Carlos A. Castellanos, Mesa, AZ (US); Matthew A. Holgate, Mesa, AZ (US)

(73) Assignee: BioForce Medical, Inc., Mesa, AZ (US)

(21) Appl. No.: 15/963,329

(22) Filed: Apr. 26, 2018

Related U.S. Application Data
(60) Provisional application No. 62/491,871, filed on Apr. 28, 2017.

(51) Int. Cl. G01N 27/447; B01L 3/00

(52) U.S. Cl. CPC G01N 27/44791; B01L 3/50273; B01L 2400/0415; B01L 2300/0645; B01L 2300/0883; G01N 27/44739

(57) ABSTRACT

A sample is analyzed by providing a device with a first electrode and a second electrode. A biocompatible coating can be formed over the first electrode. A voltage potential difference is created between the first electrode and second electrode to generate an electric field. The sample is disposed within the device and exposed to the electric field. The sample is removed from the device. The voltage potential difference is disabled after removing the sample from the device. The device is rinsed with a clean fluid after disabling the voltage potential difference. The clean fluid can be analyzed for circulating tumor cells captured from the sample by the device.

### CLAIM TO DOMESTIC PRIORITY

The present application claims the benefit of U.S. Provisional Application No. 62/491,871, filed Apr. 28, 2017, which application is incorporated herein by reference.

### FIELD OF THE INVENTION

The present invention relates in general to cancer screening, and more particularly, to isolation of circulating tumor cells from a blood sample using electric fields.

### BACKGROUND OF THE INVENTION

Circulating tumor cells (CTCs) are cells that have been shed from a tumor, and are being carried around the body in the blood stream. CTCs can operate as seeds, causing the formation of additional tumors in organs distant from the primary tumor. Observing and counting CTCs within the blood stream allows detection of cancerous tumors at an earlier stage, and with a less invasive procedure, than a biopsy. Analysis of blood samples can be performed multiple times to observe the progression of the disease, which is difficult to do with biopsies. Rising tumor cell numbers are an indicator that tumor activity is ongoing. Decreasing cell counts are a sign of successful therapy.

Circulating tumor cells are found in relatively low frequencies in the blood, on the order of one to ten CTCs per milliliter (mL) of blood. One mL of blood typically contains a few million white blood cells and a billion red blood cells, illustrating the difficulty in isolating and counting only a handful of CTCs within the same mL of blood.

Devices have been created with the intent of detecting or isolating CTCs from blood based on surface-bound protein binding, however a significant challenge is biofouling by normal leukocytes. Currently, there is an FDA-approved CTC diagnostics system on the market, called “CellSearch” by Veridex, a Johnson & Johnson company. The result of the analysis is a count of the number of CTCs in a blood sample. The CTCs are captured immunomagnetically from 7.5 mL of blood by means of ferrofluidic nanoparticles conjugated to a monoclonal antibody against epithelial cell adhesion molecule (EpCAM). However, the heterogeneity of tumor cells dictates that not all CTCs express EpCAM, and EpCAM-negative CTCs may not be detected by such system.

Others are studying alternative, unlabeled, selection methods, such as the use of microfluidic devices with integrated capture features, special filtration systems, electrical approaches such as impedance spectroscopy or di-electrophoresis, or selection based on mechanical characteristics, to name a few. The prognostic value of CTC enumeration has been well established for several tumor types. While a variety of methods exist for isolating and counting CTCs, accurately counting and characterizing CTCs suspended in a fluid remains a challenge. Therefore, a need exists for an improved device and method to isolate CTCs.

### BRIEF DESCRIPTION OF THE DRAWINGS

FIG. 1 illustrates a fluid sample with a circulating tumor cell;

FIGS. 2a-2e illustrate using an electric field to trap and isolate circulating tumor cells;

FIGS. 3a-3c illustrate adapting a tube to expose fluid flowing through the tube to an electric field;

FIGS. 4a-4e illustrate forming a chamber between two electrodes for applying an electric field to fluid in the chamber;

FIGS. 5a-5c illustrate alternative chamber configurations;

FIGS. 6a-6c illustrate an embodiment with auxiliary fluid between the electrodes and the subject fluid; and

FIGS. 7a-7c illustrate setups for injecting fluid through the chamber.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, those skilled in the art will appreciate that the description is intended to cover alternatives, modifications, and equivalents as may be included within the spirit and scope of the invention as defined by the appended claims and their equivalents as supported by the following disclosure and drawings.

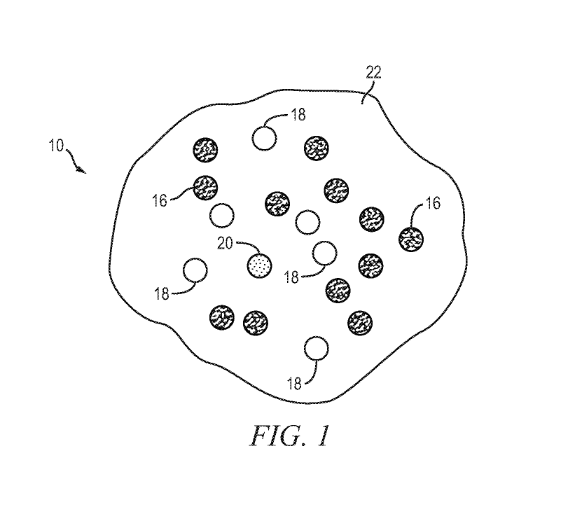

FIG. 1 illustrates a fluid sample 10. Fluid sample 10 is a portion of whole blood taken from a human including red blood cells (RBCs) 16, white blood cells (WBCs) 18, and circulating tumor cells (CTCs) 20 suspended in a blood plasma 22. Sample 10 also generally includes platelets and other normal cells found in blood that are not illustrated. In other embodiments, fluid sample 10 is a buffy coat or any other fluid taken from the body. Fluid sample 10 can also be a solution formed by mixing a bodily fluid with other desired components.

Medical laboratories desire to find out whether one or more CTCs 20 exist within fluid sample 10. Determining whether CTCs 20 exist can help diagnose cancer earlier than other methods that require an invasive procedure. Counting CTCs 20 can also help determine whether a course of treatment is working as intended.

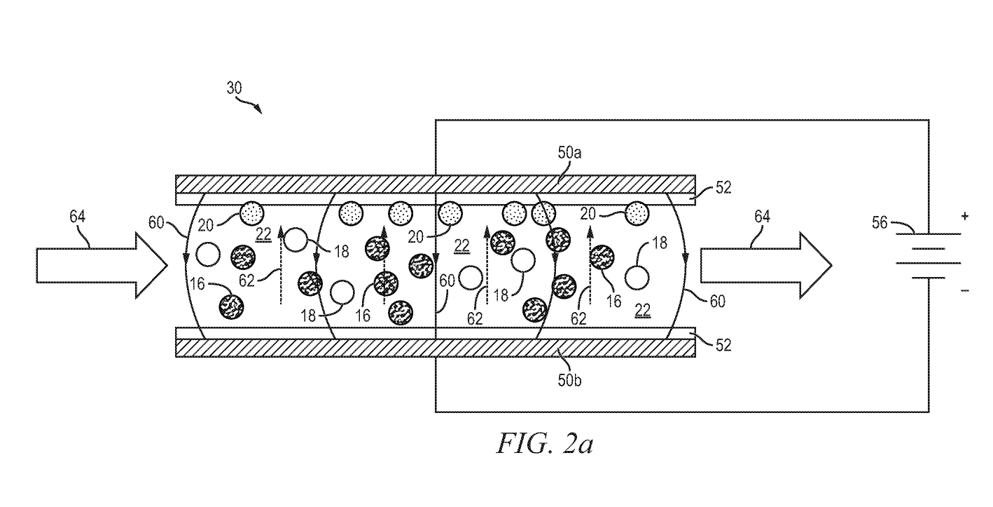

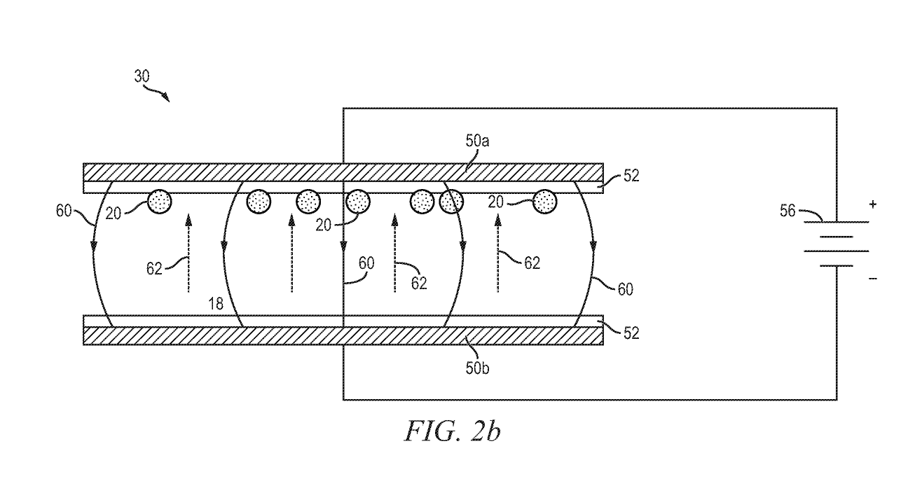

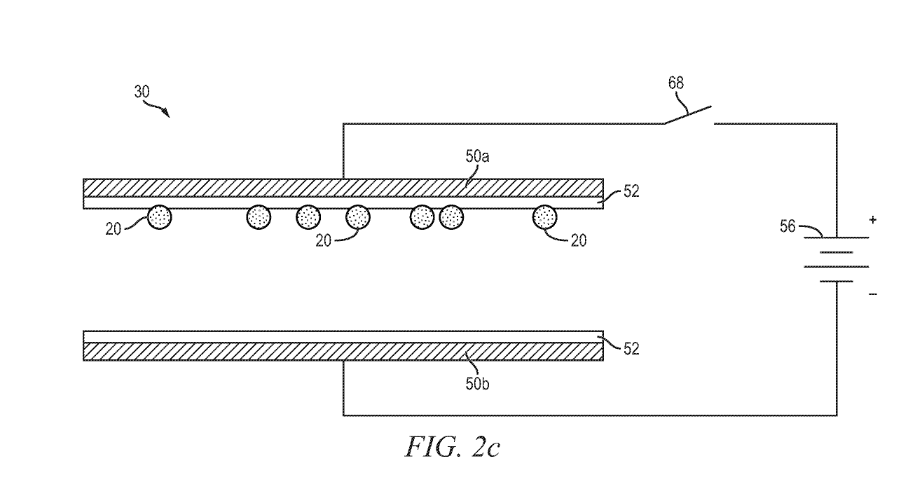

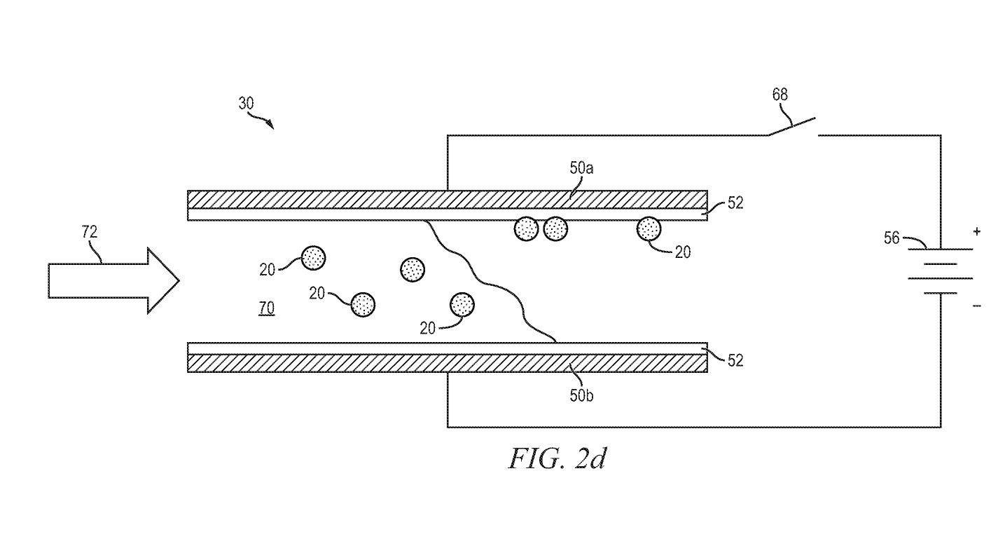

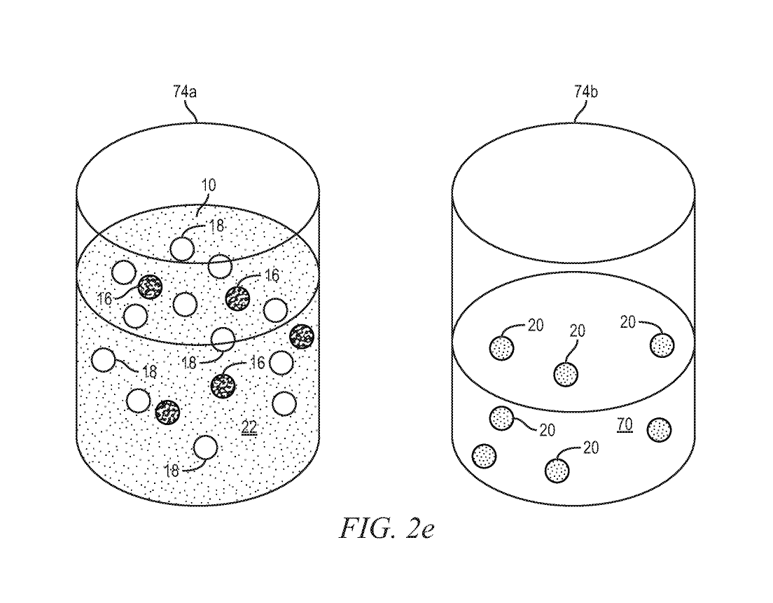

FIG. 2a illustrates fluid sample 10 being injected through a microscale flow device 30. Device 30 includes a pair of electrodes 50a and 50b. Electrodes 50 are metal plates or other conductive elements formed from, e.g., aluminum, brass, copper, or steel. Electrodes 50a and 50b operate similarly to two capacitor plates. Any suitable material for capacitor plates can be used to form electrodes 50.

Each of the electrodes 50 is optionally coated with a biocompatible coating 52. The side of each electrode 50 coated with biocompatible coating 52 is oriented to the middle of device 30. The biocompatible coating 52 is disposed between the flow of fluid sample 10 and electrodes 50 to limit physical contact between the fluid sample and the electrodes. Physical contact between CTCs 20 and electrodes 50 could cause a reaction, damaging the CTCs or otherwise render them difficult to count or characterize. Biocompatible coating 52 is a polymer, e.g., nylon or Teflon, or other material formulated to be safe for contact with CTCs 20. Biocompatible coating 52 also improves adhesion of CTCs 20 and helps resist leukocyte binding. Biocompatible coating 52 is a mesh in some embodiments, with holes sufficiently small to prevent CTCs 20 from contacting electrodes 50.

A battery 56 or other voltage source is attached between electrodes 50a and 50b to generate a voltage difference between the two electrodes. In other embodiments, voltage can be applied to electrodes 50 by a universal serial bus (USB) adapter, an AC-DC adapter plugged into a wall outlet, or any other voltage source. A microcontroller can control the voltage to allow the electrical field to be variable over time. The voltage can be controlled in an open-loop or closed-loop manner. The electric field can also be adjusted manually by an operator. In one embodiment, electrodes 50 are formed in discrete sections that allow the voltage to be controlled as a function of position, e.g., the electric field can increase as sample 10 proceeds through device 30. In FIG. 2a, electrode 50a is connected to the positive terminal of battery 56, and electrode 50b is connected to the negative terminal of battery 56. However, electrodes 50 are interchangeable in most embodiments, and can be coupled in any polarity as convenient.

The voltage potential difference between electrodes 50a and 50b generates an electric field 60 in the area between the electrodes. CTCs 20 have a significant negative charge, and therefore experience a physical force 62 pushing the CTCs toward electrode 50a due to electric field 60. Opposite electrical charges attract, while like electrical charges repel. The negatively charged electrode 50b repels the negatively charged CTCs 20, while the positively charged electrode 50a attracts the CTCs. In other embodiments, an electric field is generated by means other than two plates connected to a voltage source, e.g, by providing a magnetic field that changes value or direction with time, by using a charge generator, Van Der Graaf generator, or a similar device to accumulate an electric charge on one of the plates, or using nanoscale charged and magnetic particles.

A flow 64 of sample 10 is created between electrodes 50. As the sample 10 flows between electrodes 50a and 50b, force 62 moves CTCs 20 toward electrode 50a. CTCs 20 eventually come into contact with biocompatible coating 52 of electrode 50a. In some embodiments, biocompatible coating 52 is compressible, and CTCs 20 become partially embedded within the biocompatible coating. In another embodiment, biocompatible coating includes cavities that are sized properly for CTCs 20 to rest within the cavities. CTCs 20 are held in place by force 62 pressing the CTCs against biocompatible coating 52 while sample 10 continues flowing to allow more CTCs 20 to enter the area between electrodes 50. Sample 10 with red blood cells 16, white blood cells 18, and plasma 22 flows out from between electrodes 50 while CTCs 20 remain between the electrodes due to force 62.

Red blood cells 16 and white blood cells 18 also include a negative electrical charge and experience a force toward electrode 50a due to electrical field 60. However, the amount of electrical charge in RBCs 16 and WBCs 18 is significantly less than in CTCs 20. While the force 62 on CTCs 20 is sufficient to resist the force from flow 64 and trap the CTCs on electrode 50a, the force on RBCs 16 and WBCs 18 is significantly less. The force from electrical field 60 can cause some RBCs 16 and WBCs 18 to come into contact with biocompatible coating 52, but the force of flow 64 is generally sufficient to knock the RBCs and WBCs loose.

The magnitude of electrical field 60 is configured by controlling the voltage of battery 56, the physical dimensions of device 30, and the dielectric constant of sample 10. The electric field in device 30 should be configured to generate force 62 on CTCs 20 sufficient to capture practically all CTCs 20 within sample 10 while capturing zero, or a minimal amount, of the normal blood cells. In some embodiments, sample 10 is a solution with a bodily fluid and another fluid to control the dielectric constant between electrodes 50. In one particular embodiment, the bodily fluid is mixed with albumin to control the dielectric constant.

Sample 10 can be exposed to the area between electrodes 50 for an extended period of time to increase the percentage of CTCs 20 captured. The exposure time can be extended by holding sample 10 static within device 30 rather than having a constant flow 64 through the device, by putting sample 10 through device 30 multiple times, by slowing down the rate of flow 64, by extending the length of electrodes 50, by extending the path of fluid through the device, or by other suitable means.

Once sample 10 has been run through device 30 sufficient to trap substantially all CTCs 20 on electrode 50a, the sample is drained from the device as illustrated in FIG. 2b. CTCs 20 remain trapped on electrode 50a while plasma 22, RBCs 16, and WBCs 18 are drained into a suitable container. Battery 56 remains connected while sample 10 drains so that CTCs 20 are not flushed out along with the rest of the sample. In some embodiment, an additional rinsing step is performed while battery 56 remains connected to ensure that substantially all of sample 10 is removed other than CTCs 20. A clean fluid such as saline solution or distilled water can be used to rinse the area between electrodes 50 while electric field 60 keeps CTCs 20 within device 30.

Next, battery 56 is disconnected using a switch 68, or other suitable mechanism, to turn off electric field 60 as shown in FIG. 2c. With electric field 60 removed, force 62 is no longer applied on CTCs 20. CTCs 20 may remain embedded within or attached to biocompatible coating 52 of electrode 50a, or some CTCs may become loose within device 30.

In FIG. 2d, a clean fluid 70 without suspended biological matter, e.g., a saline solution or distilled water, is injected through device 30 with flow 72 to flush CTCs 20 from device 30 into a separate container from the rest of sample 10. FIG. 2e illustrates beakers 74a and 74b with the fluids drained from device 30. Beaker 74a includes the portion of sample 10 that was drained in FIG. 2b, including RBCs 16, WBCs 18, and plasma 22. Beaker 74b includes clean fluid 70, and CTCs 20 that were flushed from device 30 using the clean fluid in FIG. 2d.

Another option as an alternative to flushing CTCs 20 from device 30 is to have electrode 50a be removable. Electrode 50a with CTCs 20 can be removed and observed under a microscope to analyze whether CTCs existed in sample 10, and approximately how many. In one embodiment, electrode 50a includes a removable glass tray to aid in looking at CTCs 20 in a microscope. The biocompatible coating 52 on electrode 50a could be a removable sheet of glass.

Device 30 uses an electric field to isolate circulating tumor cells from a fluid sample taken from a body. CTCs 20 are isolated living so that the CTCs can be counted or grown for diagnostic or drug customization, among other purposes. With CTCs 20 isolated into a clean fluid without other biological matter, the CTCs can be counted by running clean fluid 70 through a flow cytometry device or another suitable counting mechanism. Biomarkers can be looked for within CTCs 20 to determine a type of tumor or cancer that generated the tumor cells.

While the invention is disclosed in terms of isolating circulating tumor cells, any other cell or component can be isolated according to its electric charge. A sample can be run through device 30 multiple times with the electric field incrementally stronger each pass to isolate components with a slightly weaker electric charge each pass. In other embodiments, the voltage of electrodes 50 varies by position so that different components are captured at different areas of device 30 based on their respective charges.

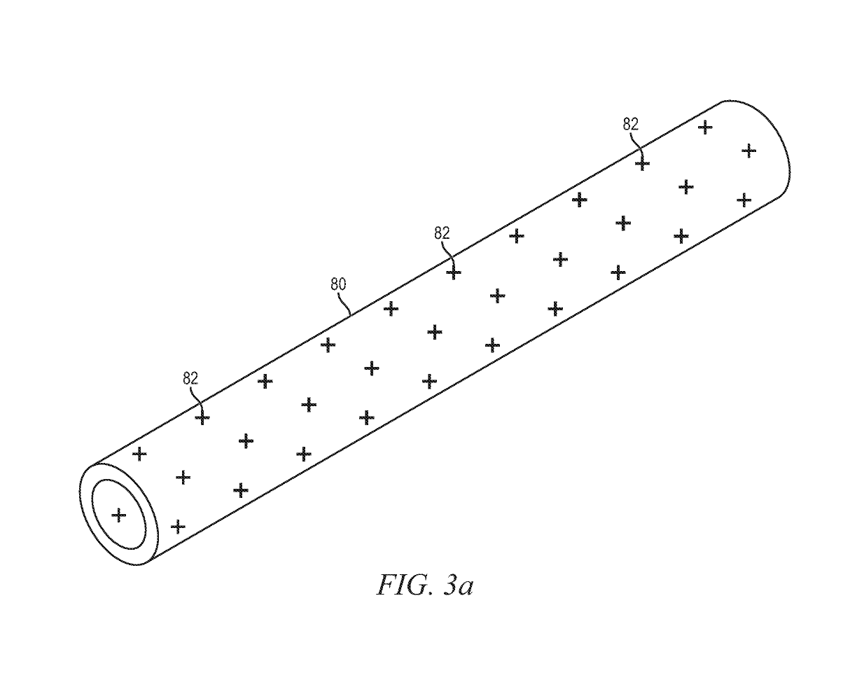

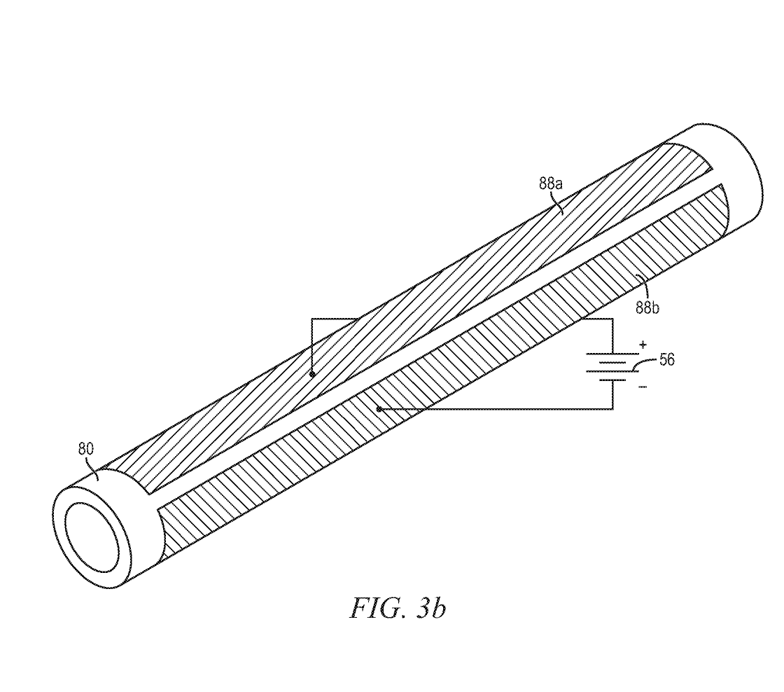

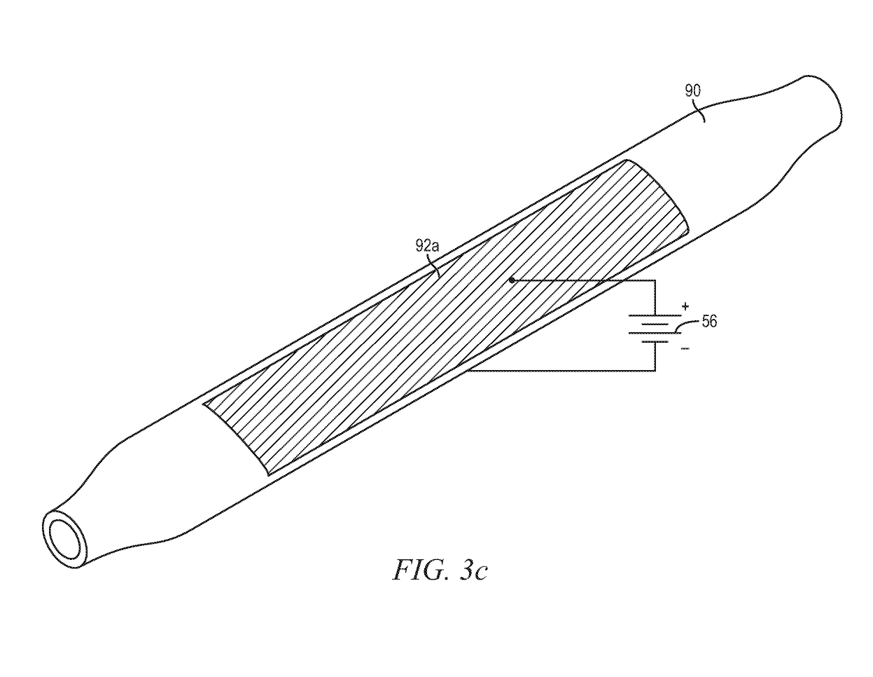

FIGS. 3a-3c illustrate embodiments where device 30 is implemented using a simple tube. In FIG. 3a, a tube 80 is implanted with positive ions 82 to attract negatively charged CTCs 20. Ions 82 are atoms or molecules with a net positive electrical charge. Tube 80 is formed of a biocompatible material, and is functionally similar to biocompatible coating 52 above. The source material for tube 80 can be mixed with ions 82 during or prior to manufacture of the tubes, or the ions can be deposited into or onto the tube afterwards. Ions 82 implanted within tube 80 are functionally similar to electrode 50a.

Sample 10 is run through tube 80, and the positive electrical charge of ions 82 is sufficient to capture CTCs 20. As above, sample 10 can be left within tube 80 for a period of time to allow all CTCs 20 to settle against the tube wall. Tube 80 can also be made longer to give CTCs 20 more time to stick in the tube. Once sample 10 is run through tube 80, the sample is drained while CTCs 20 remain stuck within the tube. Clean fluid 70 is then run through tube 80 to collect CTCs 20 for analysis. Because ions 82 are not easily disabled or removed, clean fluid 70 may need to be given a turbulent flow, or an increased pressure, to free CTCs 20 from the force of the electric field. In one embodiment, negative ions are embedded within tube 80 to capture cells with a positive electric charge. In another embodiment, positive ions are implanted in the sidewalls of tube 80 opposite negative ions to force CTCs 20 to one side of the tube.

FIG. 3b illustrates tube 80 with an electrical field generated by metal plates 88a and 88b rather than with embedded ions. Plates 88a and 88b can be plated onto tube 80 by normal metal deposition techniques. In another embodiment, plates 88 are sheet metal rolled to correspond to the surface of tube 80 and then attached to the tube by an adhesive, clip, or another suitable method. Battery 56 may be connected to plates 88 by wires soldered to plates 88. Plates 88 and battery 56 allow the electrical field to be turned on and off as with device 30 above.

FIG. 3c illustrates a tube 90 which includes a flattened portion. Metal plates 92 are formed on two opposite surfaces of the flattened portion in a similar manner to plates 88 in FIG. 3b. The flattened aspect of tube 90 can provide a more uniform electric field and forces CTCs 20 closer to the positively charged plate. A flat tube 90 can also have an electrical field generated by embedded ions as in FIG. 3a.

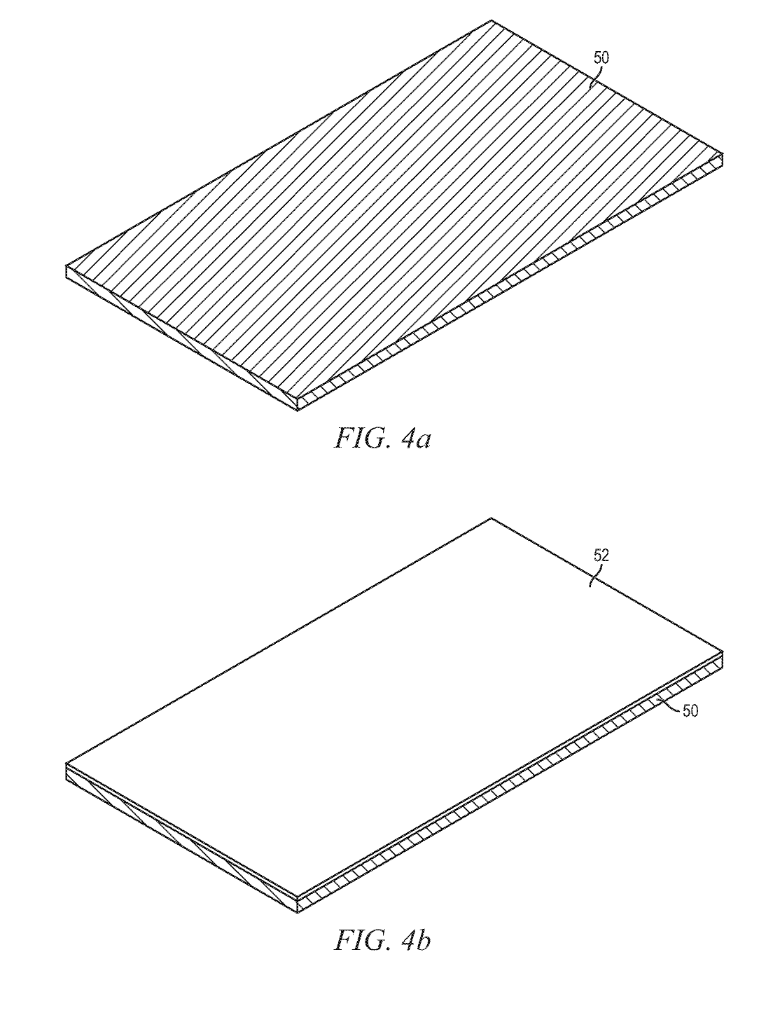

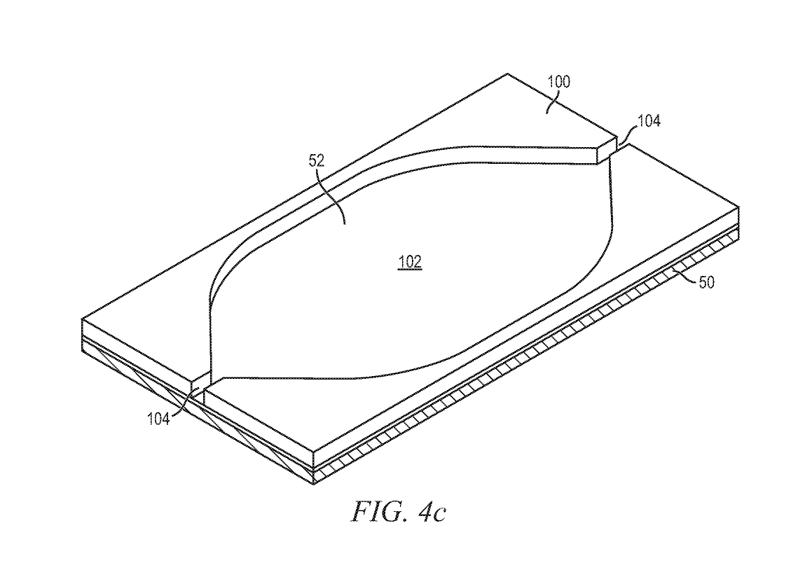

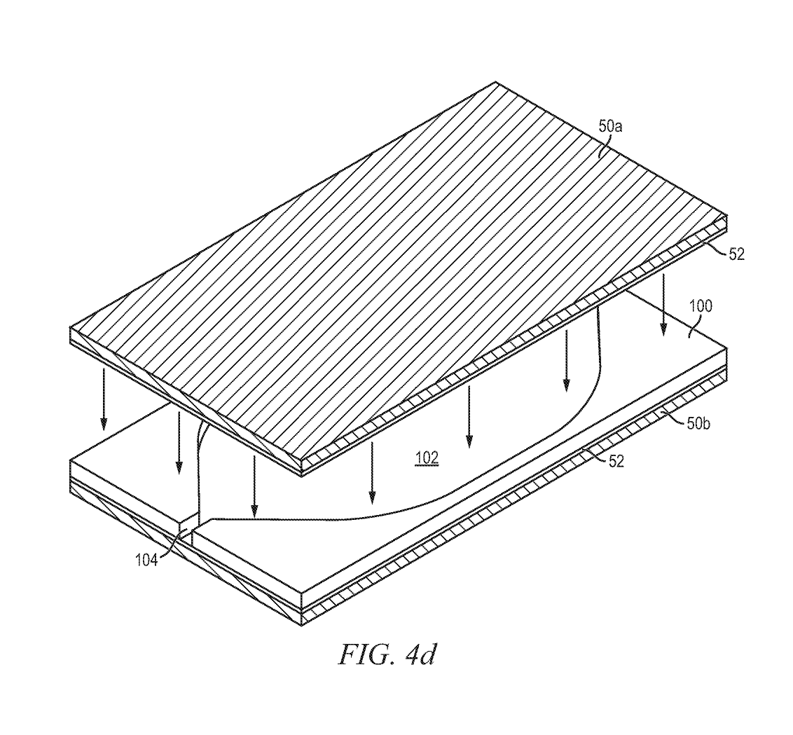

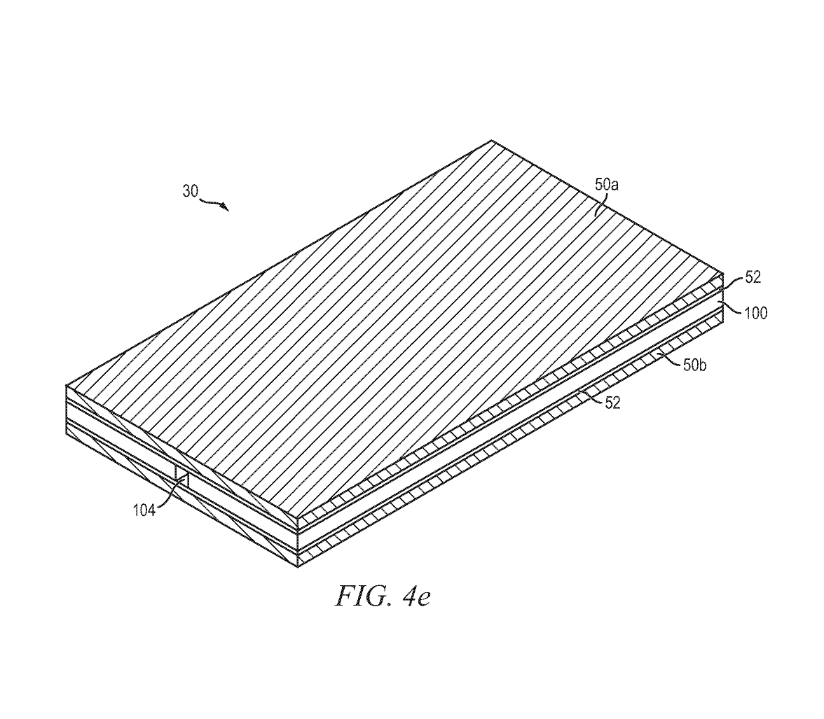

FIGS. 4a-4e illustrate manufacturing of a device 30. In FIG. 4a, a sheet of metal is provided for electrodes 50. Electrodes 50 are manufactured by cutting a large piece of sheet metal into appropriately sized plates. In FIG. 4b, biocompatible coating 52 is coated onto electrodes 50. Biocompatible coating 52 can be a liquid applied by spray coating, roll coating, or using a brush. Biocompatible coating 52 can be purchased as a sheet and laminated or simply laid onto electrodes 50. Other deposition techniques appropriate for the material of biocompatible coating 52 are used in other embodiments. In some embodiments, biocompatible coating 52 is applied before cutting the source sheet metal into individual electrodes 50.

In FIG. 4c, a fluid guide layer 100 is formed or disposed on one of the electrodes 50. Fluid guide layer 100 includes a central cavity 102 to keep fluid contained within device 30 as the fluid flows through the device. Fluid guide layer 100 is formed from a sheet of polymer material and attached onto biocompatible coating 52 after cutting cavity 102. Fluid guide layer 100 can be formed from Teflon, polyvinyl chloride (PVC), acrylic, glass, or other suitable materials.

Fluid guide layer 100 is attached to electrode 50 and biocompatible coating 52 using an adhesive layer in some embodiments. In another embodiment, fluid guide layer 100 is 3D printed onto electrode 50 and biocompatible coating 52. Fluid guide layer 100 includes inlet and outlet ports 104 to allow fluid into and out of cavity 102. Ports 104 can have a hose fitting attached within the ports to easily attach and detach hoses to and from device 30. The hose fittings can be attached within ports 104 using a silicone or other caulk-like adhesive to seal the ports from leakage. Hoses could also be glued directly into ports 104. In another embodiment, ports 104 include a threaded interface for attachment of threaded fittings and connectors.

In FIG. 4d, another electrode 50 with biocompatible coating 52 is disposed over the first electrode with fluid guide layer 100 sandwiched between the two biocompatible coating layers. The second electrode 50 is attached by an adhesive or other suitable mechanism. Electrode 50a seals the central cavity 102 so that fluid only normally flows into and out of the chamber through ports 104. FIG. 4e illustrates a completed device 30. Two electrodes 50a and 50b flank a central chamber 102 that guides fluid between the two electrodes. Fluid is allowed into and out of the chamber through ports 104, and otherwise held between electrodes 50 by fluid guide layer 100. A biocompatible coating 52 is disposed between the central chamber 102 and each of the electrodes 50. A hose can be attached to each of the ports 104 and routed to other equipment to control ingress and egress of fluid.

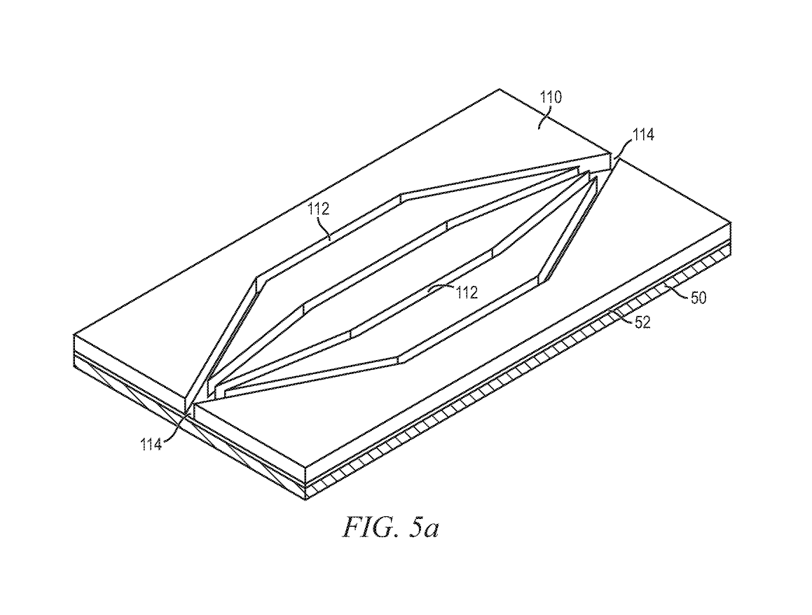

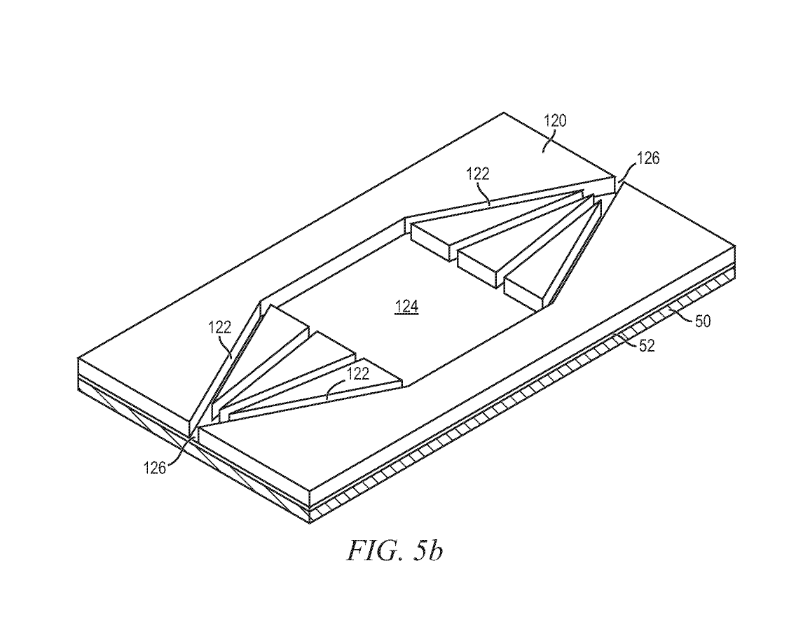

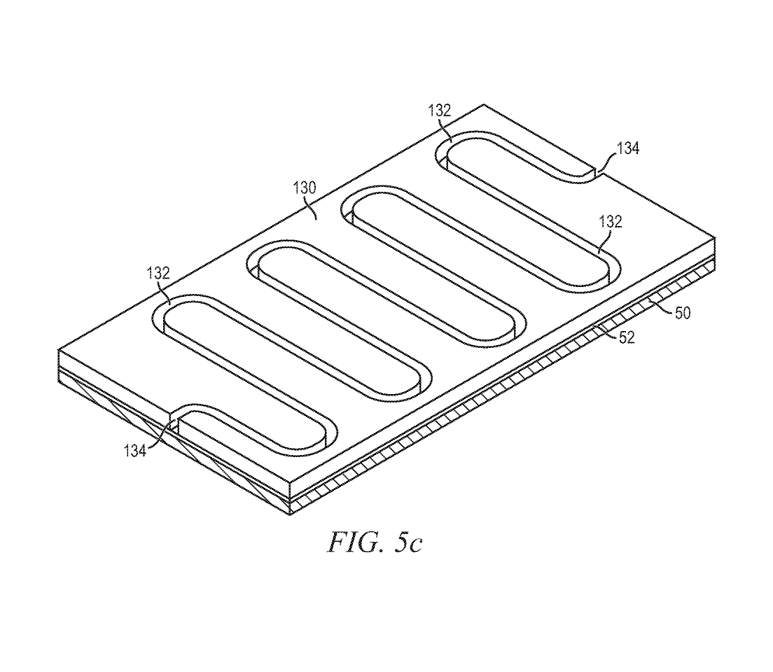

A thickness of fluid guide layer 100 and shape of central cavity 102 can be configured to modify the flow rate of fluid through device 30. FIGS. 5a-5c illustrate three non-limiting options for paths of fluid guided through device 30. FIG. 5a illustrates fluid guide layer 100 replaced by fluid guide layer 110. Guide layer 110 includes four separate paths 112 for fluid rather than a single large chamber. Having multiple narrow paths 112 slows flow of fluid through the device and also makes filling the height between the plates with fluid easier. Inlet and outlet ports 114 are similar to ports 104. A fitting can be threaded into ports 114, glued in, or otherwise mounted to allow attachment of tubing.

FIG. 5b illustrates guide layer 120 with four separate fluid paths 122 leading to a central cavity 124. Fluid paths 122 at the inlet side help distribute fluid across the width of cavity 124, while the fluid paths at the outlet help slow fluid flow out of the device. In some embodiments, fluid paths 122 only exist at the inlet or outlet side of central cavity 124. Inlet and outlet ports 126 are similar to ports 104 and 114.

FIG. 5c illustrates guide layer 132 with a single serpentine fluid pathway 132 extending between inlet and outlet ports 134. Fluid pathway 132 winds back and forth across the footprint of electrode 50 to increase the length of fluid flow through the device. A longer pathway between the electrodes increases the exposure of each unit of fluid to the electric field, thus increasing the likelihood of capturing each CTC 20.

The serpentine shape of pathway 132 can be configured with tighter turns to increase the length of the pathway for the same size electrodes 50. Other shapes of pathway 132 are possible, such as square or triangular turns rather than rounded curves. In one embodiment, a plurality of paths as in FIG. 5a are each given a serpentine shape as in FIG. 5c. While FIGS. 5a-5c illustrate three specific embodiments, fluid can be guided between electrodes 50 in any suitable path or combination of multiple paths. Inlet and outlet ports 134 are similar to the ports in other embodiments, and allow attachment of fittings or connectors.

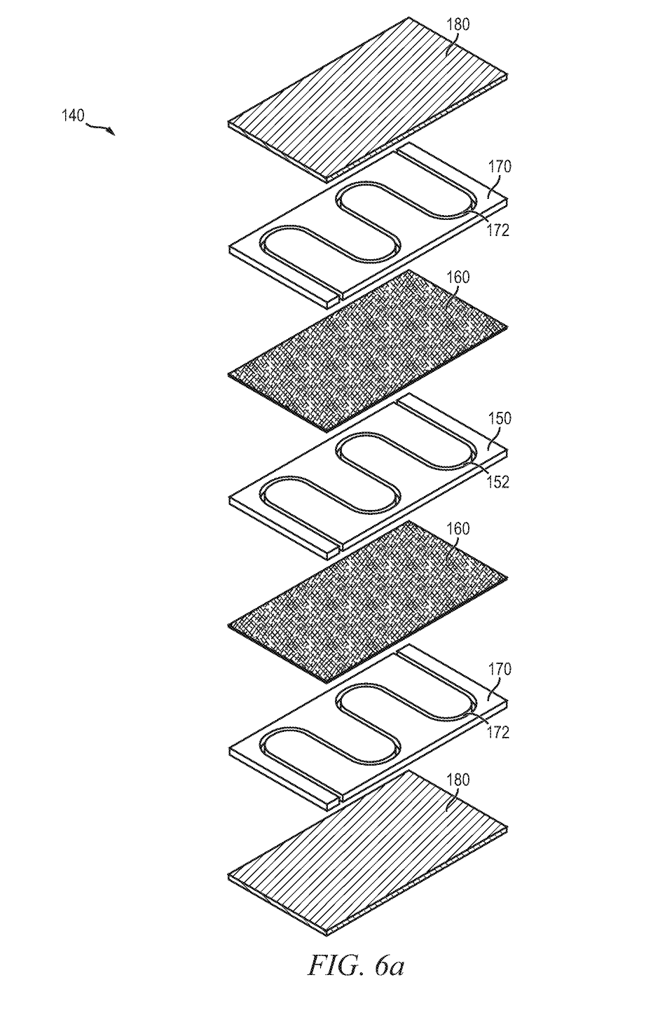

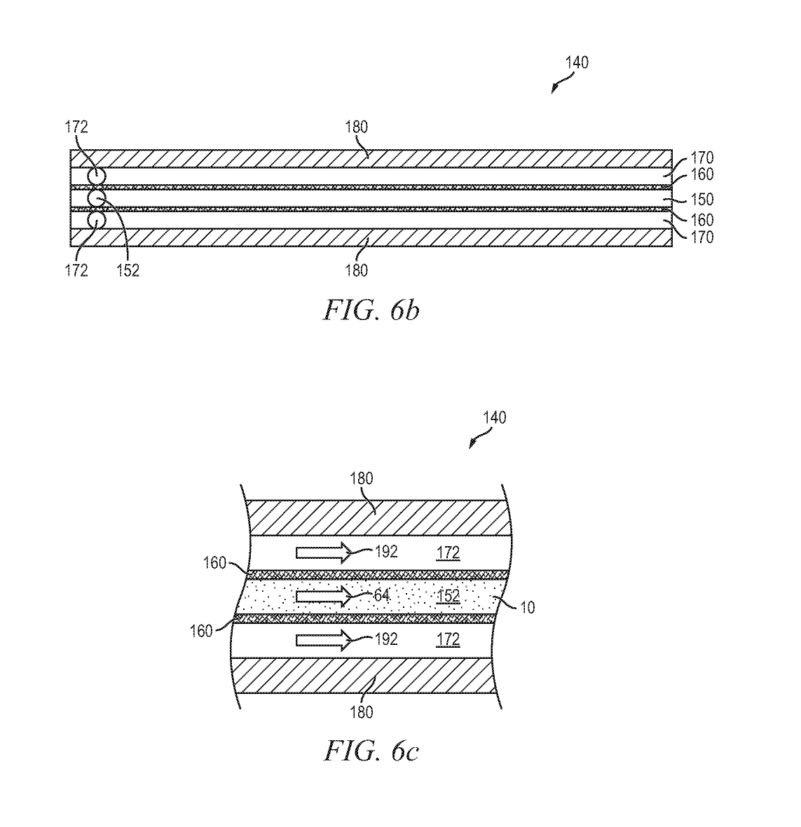

FIGS. 6a-6c illustrate a device 140 where the main fluid flow is separated from the electrodes by an auxiliary fluid rather than only by biocompatible coating 52. FIG. 6a illustrates an exploded view of the layers of device 140. Device 140 includes a main fluid guide layer 150 similar to the above fluid guide layers. Fluid guide layer 150 includes a serpentine fluid path 152, but any suitable fluid pathway can be used, including any of the above disclosed. A bodily liquid to be tested for CTCs is routed through fluid guide layer 150 of device 140.

Mesh layers 160 lie on both the top and bottom of guide layer 150. Mesh layers 160 are a mesh or fabric with small openings distributed across the surface area. Mesh layers 160 are a fine mesh with openings on the order of one micrometers (μm) or less, which allow liquid molecules such as water to traverse through the mesh but not larger particles such as CTCs 20. Mesh 160 can be attached to both sides of fluid guide layer 150 by an adhesive. Mesh 160 is similar to biocompatible coating 52 and serves a similar purpose. Some of the same materials are usable for both mesh 160 and biocompatible coating 52.

A pair of auxiliary flow guide layers 170 are disposed on either side of mesh layers 160 from the main guide layer 150. Auxiliary guide layers 170 include auxiliary flow pathways 172 that allow the flow of a clean liquid through device 140 in parallel with the main flow in pathway 152. Pathways 172 guide a clean fluid along the same path as pathway 152, both above and below the central pathway, between main pathway 152 and electrodes 180.

FIG. 6b illustrates the layers of device 140 put together, while FIG. 6c is a partial cross-section through pathways 152 and 172. Meshes 160 are sandwiched between main guide layer 150 and the two auxiliary flow guides 170. The stack of three fluid guiding layers 150 and 170 with meshes 160 is sandwiched between electrodes 180. Device 140 includes separate inlets and outlets for main flow path 152 and the auxiliary flow paths 172. Six different fittings can be used to attach six different hoses to control flow to the three fluid paths separately. A segment of tubing can be used to connect the two pathways 172 serially to simplify operation.

Sample 10 is fed through pathway 152 while a voltage potential difference between electrodes 180 creates an electrical field through device 140. CTCs 20 in the sample are forced toward the positively charged electrode 180 as in FIG. 2a. At the same time, a clean fluid is fed through pathways 172. FIG. 6c illustrates the flow 64 of sample 10 in parallel two flows 192 of a clean fluid. Because fluid is in contact with electrically charged electrodes 180, bubbles will tend to form in the fluid on the electrodes, e.g., because of water molecules splitting into hydrogen and oxygen. The bubbles can cause harm to CTCs 20. Mesh layers 160 are used to keep CTCs 20 separated from electrodes 180, and therefore also from the bubbles generated in pathway 172.

In some embodiments, pathways 172 are filled with fluid and sealed. The existence of a clean fluid in pathways 172 is enough to keep sample 10 and CTCs 20 separated from bubbles generated by electrodes 180. In other embodiments, a clean fluid is circulated through pathways 172 as flow 192 to constantly flush bubbles from within device 140. Auxiliary flow 192 can be the same direction and flow rate as main flow 64, or have a different direction or rate.

As above, sample 10 is routed through pathway 152 with electrodes 180 energized, and then the sample is drained while CTCs 20 remain stuck to mesh 160 in device 140. The voltage source is disconnected from electrodes 180 to remove the force applied to CTCs 20, then a clean fluid is routed through main pathway 152 to flush out and preserve the CTC separately from the rest of sample 10. Device 140 operates similarly to device 30 above, but includes auxiliary flow pathways 172 between the main pathway 152 and electrodes 180 rather than only a biocompatible coating.

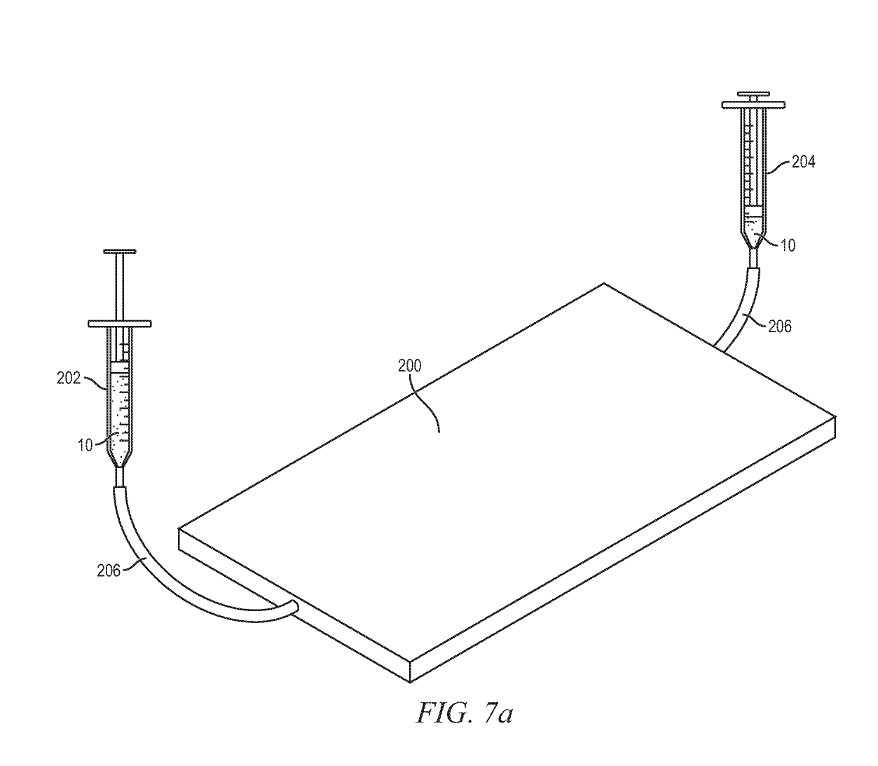

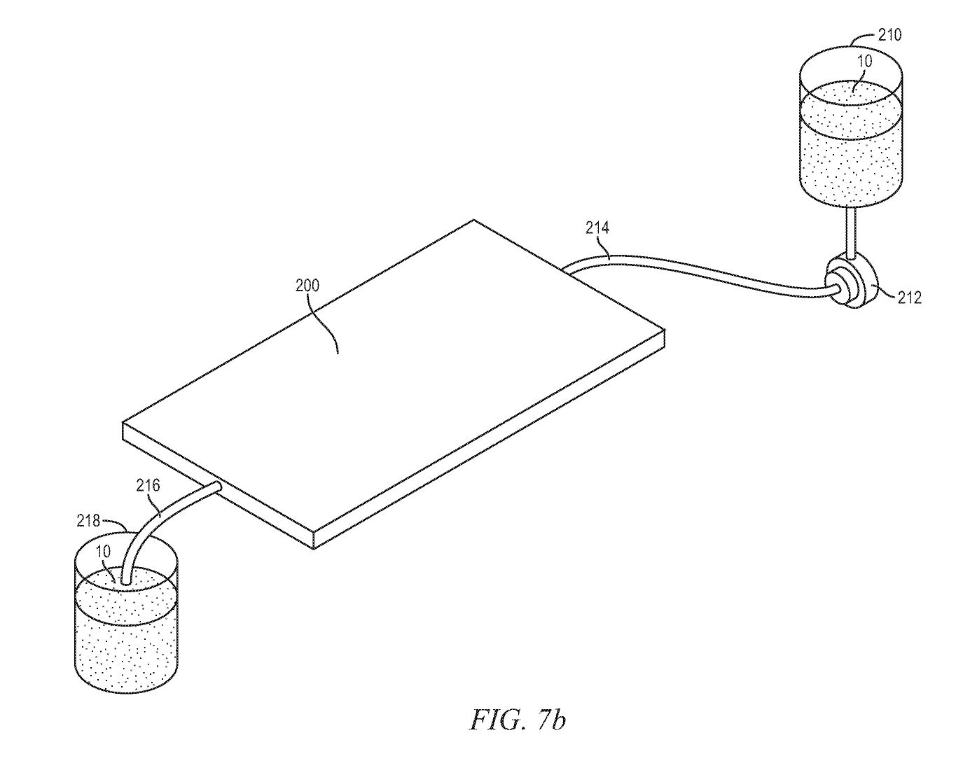

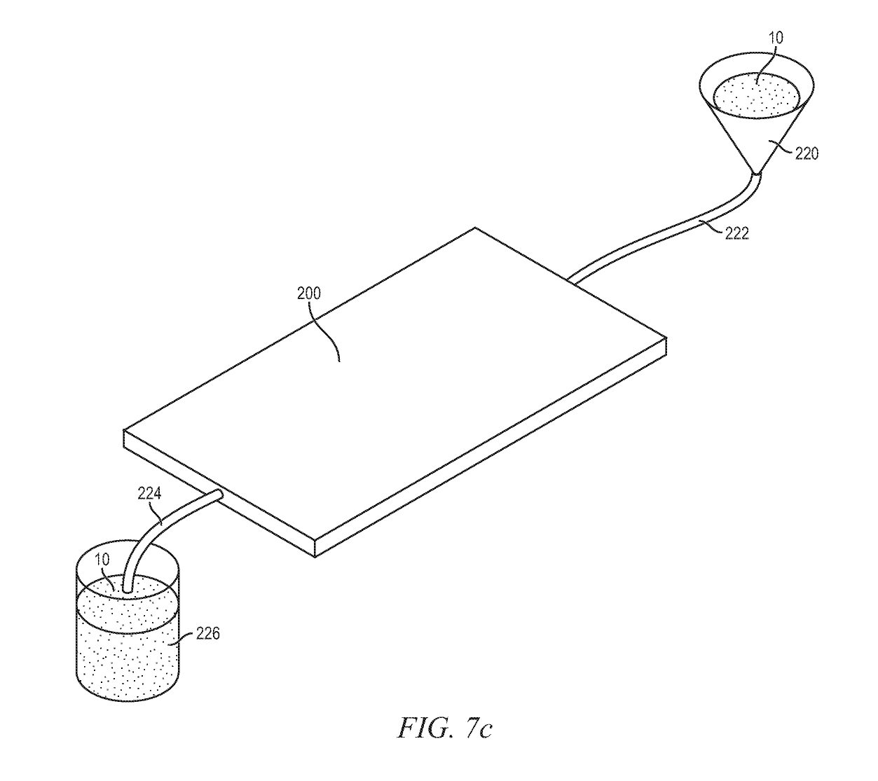

FIGS. 7a-7c illustrate some exemplary laboratory setups for feeding a sample through an electric field generating device 200. Device 200 is similar to devices 30 and 140 above, and includes a fluid pathway for fluid sample 10 to be routed through an electric field. The electric field traps CTCs 20 as the sample 10 flows through device 200.

In FIG. 7a, a pair of syringes 202 and 204 is used to inject sample 10 in one end of device 200, and withdraw the sample from the other end. Syringes 202 and 204 are coupled to device 200 by hoses 206. In some embodiments, a device 200 could be operated with only a single syringe. Sample 10 is injected into device 200, allowed a sufficient amount of time for CTCs 20 to be captured, and then drawn out using the same syringe.

In FIG. 7b, a pump 212 pulls sample 10 from a source beaker 210 and forces the sample into device 200. The force of pump 212 feeds sample 10 through device 200 and into and output beaker 218. Pump 212 is connected to device 200 by a hose 214, and hose 216 routes fluid from device 200 to beaker 218.

In FIG. 7c, sample 10 is poured into a funnel 220 and flows through tubing 222 to device 200. Sample 10 flows through device 200 by force of gravity and drains through tubing 224 into beaker 226. The rate of sample 10 flowing through device 200 can be controlled by the rate of pouring the sample into funnel 220, and by the slope that device 200 is held at. In embodiments that have auxiliary liquid flows 192 between the electrodes and the main sample flow 64, fluid can be static within device 200, or can flow through the device by any of the above described methods.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of analyzing a sample, comprising:
providing a device including a first electrode and a second electrode;
providing a voltage potential difference between the first electrode and second electrode to generate an electric field;
disposing the sample within the device and exposed to the electric field;
removing the sample from the device; and
disabling the voltage potential difference after removing the sample from the device.

2. The method of claim 1, further including disposing a biocompatible coating over the first electrode.

3. The method of claim 1, further including disposing a clean fluid in the device between the first electrode and the sample.

4. The method of claim 1, further including rinsing the device with a first clean fluid after disabling the voltage potential difference.

5. The method of claim 4, further including analyzing the first clean fluid for tumor cells captured from the sample by the device.

6. The method of claim 4, further including rinsing the device with a second clean fluid prior to disabling the voltage potential difference.

7. The method of claim 1, further including providing the device to include a serpentine fluid pathway between the first electrode and second electrode.

8. A method of analyzing a sample, comprising:
generating an electric field within a device;
disposing the sample within the device and exposed to the electric field; and
removing the sample from the device.

9. The method of claim 8, further including generating the electric field between a first electrode and a second electrode.

10. The method of claim 9, further including disposing a biocompatible coating over the first electrode.

11. The method of claim 9, further including disposing a clean fluid in the device between the first electrode and the sample.

12. The method of claim 9, further including:
removing a portion of the first electrode after removing the sample from the electric field; and
observing the portion of the first electrode using a microscope.

13. The method of claim 8, further including:
disabling the electric field after removing the sample; and
disposing a clean fluid within the device after disabling the electric field.

14. The method of claim 13, further including:
removing the clean fluid from the device; and
counting a number of molecules from the sample that are in the clean fluid.

15. The method of claim 8, further including adding a substance to the sample to control a dielectric constant of the sample.

16. A medical device, comprising:
a first electrode;
a second electrode;
a voltage source coupled between the first electrode and second electrode; and
a first fluid pathway disposed between the first electrode and second electrode.

17. The medical device of claim 15, wherein the first fluid pathway includes a serpentine shape.

18. The medical device of claim 15, further including a plurality of first fluid pathways disposed between the first electrode and second electrode.

19. The medical device of claim 15, further including a second fluid pathway disposed between the first fluid pathway and the first electrode.

20. The medical device of claim 19, further including a mesh disposed between the first fluid pathway and second fluid pathway.
